(19) United States
(12) Patent Application Publication
(10) Pub. No.: US 2023/0323990 A1
(43) Pub. Date: Oct. 12, 2023

(54) ADAPTER FOR CARBONIC GAS TUBES

(71) Applicant: LUCANA COMPANY LLC, Orlando, FL (US)

(72) Inventors: Lucas de Palma BORASCHI, Orlando, FL (US); Dalari BORASCHI, Orlando, FL (US)

(21) Appl. No.: 17/716,532

(22) Filed: Apr. 8, 2022

(51) Int. Cl. F16L 33/24; F16L 33/207

(52) U.S. Cl. CPC F16L 33/24; F16L 33/2071

(57) ABSTRACT

Adapter for carbon dioxide tubes including a tube provided with an inner channel with hollow ends, having an end that has an annular shoulder with a flexible surface provided with outer ribs that fits into the connection area of a hose, which is, in turn, associated with the carbon dioxide tube, by overlapping and deformation, and the outer ribs of the tube fit into the ribs arranged in the inner channel of the annular shaped sleeve.

### FIELD OF THE INVENTION

The present patent of invention describes an adapter for tubes that store carbon dioxide, said adapter coupled to the hose that dispenses the gas and presenting means for sealing and easy handling for hygienic operations of ducts and confined spaces, such as air conditioning installations.

### BACKGROUND OF THE INVENTION

Compact pressurized devices that store liquid CO₂, known as CO₂ blasters, basically comprise a tank equipped with a nozzle to which valves and hoses are attached that allow for the dispensing of carbon dioxide in a targeted manner for different applications.

Notably, such pressurized devices, as they dispense a jet of carbon dioxide under high pressure, are useful to clean small confined spaces, without posing risks to the operator.

Specifically in relation to pipe cleaning, the emission of pressurized jets is desirable, but generally such an operation is hampered by the need to move the cylinder into places of difficult access or in operations at height. Still, it is necessary to use adapters with sealing means that allow easy coupling, without requiring the use of tools.

The document US2016361739 describes a quick disconnect hose fitting having a male distal end, a widened proximal end, and an inner channel having a threaded sleeve with an inner channel, whereby the distal end of the fitting extends therethrough, wherein the sleeve is sized to bear against the widened proximal end of the hose fitting.

The document JP2019/044841 describes an adapter for connection of the drain hose, air conditioning system and maintenance method for drain piping that comprises a threaded sleeve that ensures the locking of a pipe segment with an inner channel.

The document BRPI0510889 describes a sleeve coupled around the extension of a nozzle.

The document BRPI8602923 describes a connector that comprises a first tubular part that incorporates, in the middle, an outer annular projection facing the coupling end of the first part defined by a slope and, near its coupling end, an internally threaded tubular sleeve, with an inner diameter greater than the end diameter of the coupling of the first part, so as to enclose said end, maintaining with it a radial distance sufficient for the adaptation of the end of the hose around said coupling end of the first part.

The prior art connectors, however, have a structure that makes assembly and handling difficult, when the user is using it, especially when working at heights or similar, wherein dexterity and speed are required for assembly. Furthermore, as it is an adapter for application in a gas pipe, the sealing and thread fitting must be efficient and easy to install, but resistant.

### SUMMARY OF THE INVENTION

In this sense, the object of the present invention is an adapter for carbon dioxide tubes that has a tube and a sleeve, associated by means of a thread, with the tube fitting into the hose connection region by means of interference with deformation, and locking by the thread, improving the sealing.

### BRIEF DESCRIPTION OF THE DRAWINGS

FIG. 1 represents the perspective view of the adapter, showing the tube and the sleeve.

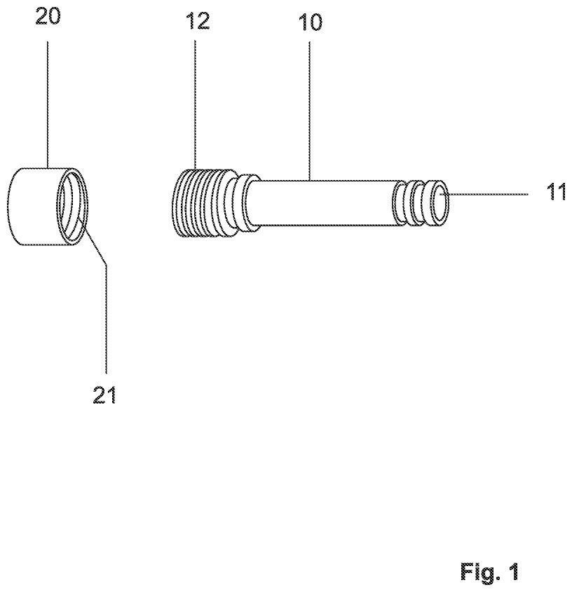

FIG. 2 represents the perspective view of the carbon dioxide tube with the hose attached to it.

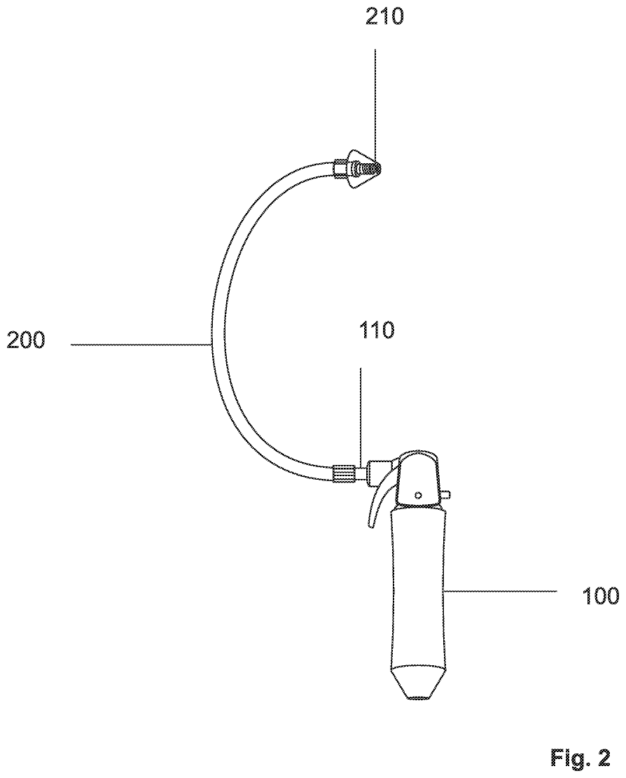

FIG. 3 represents the tube attached to the hose connection area.

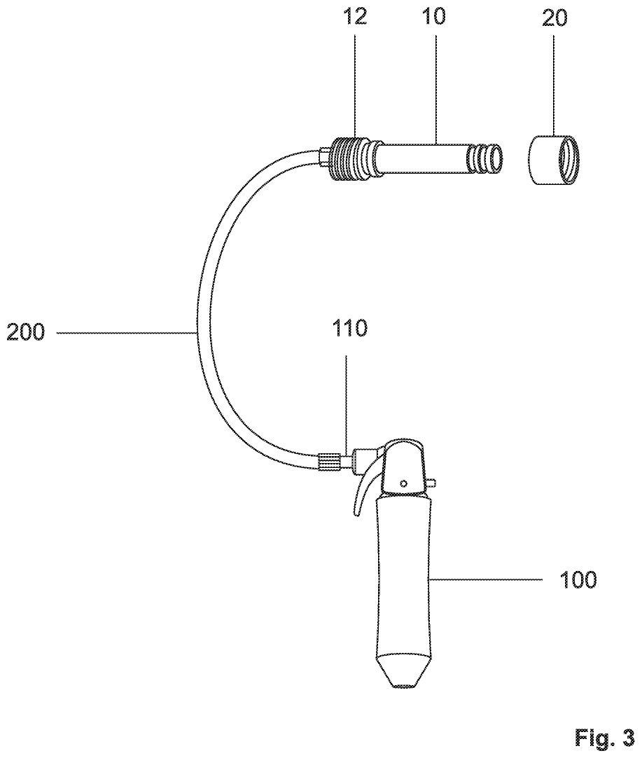

FIG. 4 represents the adapter attached to the hose connection area, which, in turn, is attached to the carbon dioxide tube.

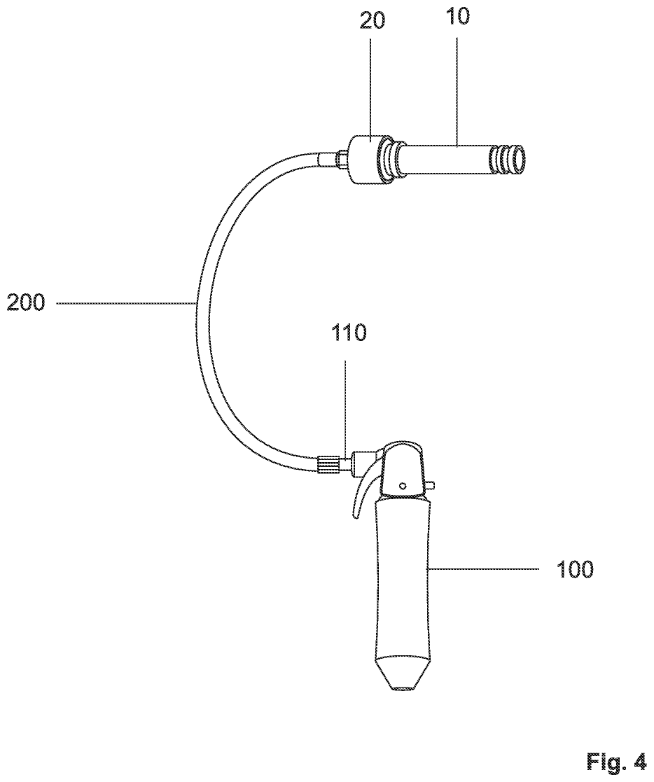

### DETAILED DESCRIPTION OF THE INVENTION

The adapter for carbon dioxide tubes (100), object of the present invention, comprises a tube (10) and a sleeve (20) that are linked by means of a thread for coupling them into the terminal (210) of a hose (200) whose opposite end is coupled with the nozzle (110) of a tube that stores carbon dioxide (100).

The tube segment (10) has an inner channel with hollow ends (11), having one end provided with an annular shoulder with a surface provided with outer ribs (12), said annular shoulder (12) presenting a flexible surface.

A sleeve comprises an annular shaped body (20) with an inner channel provided with ribs (21), said sleeve (20) having a diameter size that allows coupling with the annular shoulder end (12) of the tube (10).

For connection to the terminal (210) of the hose (200), the annular shoulder region (12) arranged at the tube segment end (10) is manually forced to fit by overlapping the terminal (210), so that the region of the annular shoulder (12) fits by deformation, yielding and molding to the outer surface of the terminal (210) to ensure locking and sealing.

Once the tube segment (10) is installed, the sleeve (20) is inserted from the free end of said tube segment (10), so that the region with inner thread (21) is associated with the outer ribs (12) arranged on the annular shoulder of the tube segment (10).

The tube segment (10) and the sleeve (20), associated at the terminal (210) of the hose (200), provide a structure suitable for directing the gas dispensed from the carbon dioxide tube (200) for cleaning small gauge pipes, such as air conditioning drains and others.

1. An adapter for carbonic gas tubes comprising:
(a) a tube segment provided with an inner channel with hollow ends and an annular shoulder end of flexible surface with external ribs;
(b) an annular shaped sleeve with inner ribs coupled to the outer ribs of the annular shoulder of the tube segment; and
(c) a hose with a terminal which is overlapped by the annular shoulder end of the tube segment.
